(19) United States
(12) Patent Application Publication
(10) Pub. No.: US 2015/0244770 A1
(43) Pub. Date: Aug. 27, 2015

(54) PHOTO MEDIA PLAYING METHOD AND PHOTO MEDIA PLAYING SYSTEM FOR PLAYING PHOTO MEDIA FILE OF SOCIAL NETWORKING SITE IN AREA NETWORK

(71) Applicant: Primax Electronics Ltd., Taipei (TW)

(72) Inventor: JUNG-CHANG YANG, Taipei (TW)

(73) Assignee: Primax Electronics Ltd., Taipei (TW)

(21) Appl. No.: 14/286,703

(22) Filed: May 23, 2014

(30) Foreign Application Priority Data
Feb. 21, 2014 (TW) 103105866

(51) Int. Cl. H04L 29/08; G06F 17/30; H04L 12/18

(52) U.S. Cl. CPC H04L 67/08; H04L 12/1813; G06F 17/3028

(57) ABSTRACT

A photo media playing method for playing photo media files of a social networking site in an area network is provided. Firstly, the digital media server logins into the social networking site. Moreover, plural album data, plural photo media data and plural media thumbnails corresponding to the social networking site are previously stored in the digital media server. Then, an active control device is connected to the digital media server, so that the plural media thumbnails may be viewed by the user. After one of the plural media thumbnails is selected, the photo media file corresponding to the selected media thumbnail is transmitted from the digital media server to the area network. Consequently, the photo media file is played by the active control device of the area network.

### FIELD OF THE INVENTION

The present invention relates to a photo media playing method, and more particularly to a photo media playing method for playing photo media files in an area network.

### BACKGROUND OF THE INVENTION

Generally, an area network comprises a local area network (LAN), a metropolitan area network (MAN) and a wide area network (WAN). With increasing development of science and technology, the area network further comprises a universal plug and play (UPnP) system and a Digital Living Network Alliance (DLNA) system. For example, the DLNA system is an alliance organization that is composed by the manufacturers of consumer electronics products, mobile phones and computers. The DLNA is responsible for defining unified transmission specifications to allow a variety of products from different manufacturers to be connected and communicated with each other. Consequently, a first electronic device and a second electronic device that comply with the DLNA protocol can be in direct communication with each other in order to transfer data or make synchronization actions.

First of all, some architectures of the DLNA system will be illustrated as follows. FIG. 1 schematically illustrates the architecture of a first conventional DLNA system. As shown in FIG. 1, the first conventional DLNA system 1 comprises a network router 10, a digital media server (DMS) 11, and a digital media player (DMP) 12. The network router 10 is connected to an internet (not shown). In addition, the network router 10 is in communication with the digital media server 11 and the digital media player 12. Consequently, the communication between the digital media server 11 and the digital media player 12 is established through the network router 10. The digital media server 11 comprises a first storage element 111 for storing a media file 15. The media file 15 is for example an audio file, a photo file or a video file. After the digital media player 12 is in communication with the digital media server 11, the digital media player 12 may search the media file 15 from the digital media server 11. After the media file 15 is selected by the user through the digital media player 12, the media file 15 is transmitted from the digital media server 11 to a second storage element 121 of the digital media player 12. After the media file 15 is received by the digital media player 12, the media file 15 that is temporarily stored into the second storage element 121 can be played by the digital media player 12.

FIG. 2 schematically illustrates the architecture of a second conventional DLNA system. As shown in FIG. 2, the second conventional DLNA system 2 comprises a network router 20, a digital media server (DMS) 21, and a digital media renderer (DMR) 23. The communication between the digital media server 21 and the digital media renderer 23 is established through the network router 20. Similarly, the digital media server 21 comprises a first storage element 211 for storing a media file 25. In addition, the digital media server 21 further provides a control function of controlling operations of the digital media renderer 23. The digital media renderer 23 is used for receiving and playing the media file 25 that is transmitted from the digital media server 21. After the control function of the digital media server 21 is utilized to select the stored media file 25 from the digital media server 21, the media file 25 is transmitted from the digital media server 21 to the digital media renderer 23. Consequently, the media file 25 can be played by the digital media renderer 23.

FIG. 3 schematically illustrates the architecture of a third conventional DLNA system. As shown in FIG. 3, the third conventional DLNA system 3 comprises a network router 30, a digital media server (DMS) 31, a digital media renderer (DMR) 33, and a digital media controller (DMC) 34. The communication between the digital media server 31, the digital media renderer 33 and the digital media controller 34 is established through the network router 30. The digital media server 31 comprises a first storage element for storing a media file 35. The digital media renderer 33 is used for receiving and playing the media file 35 that is transmitted from the digital media server 31. The digital media controller 34 provides a control function. After the control function of the digital media controller 34 is utilized to select the stored media file 35 from the digital media server 31, the media file 35 is transmitted from the digital media server 31 to the digital media renderer 33. Consequently, the media file 35 may be played by the digital media renderer 33.

As mentioned above, the digital media server, the digital media controller, the digital media renderer and the digital media player included in the same DLNA system may transfer or play media files through the network router. The digital media server and the digital media renderer may be referred as passive control devices that can be controlled. Moreover, the digital media controller and the digital media player may be referred as active control devices that can control the passive control devices. For example, a user in a living room may allow a smart phone to be connected to a computer host in a study room. Moreover, through the smart phone, the user may browse the audio files in the computer host and select a desired audio file from the computer host. Then, the selected audio file is transmitted from the smart phone to a stereo device in the living room. After the audio file is received by the stereo set, the audio file is played by the stereo device. Consequently, the purposes of conveniently and quickly sharing media contents can be achieved by the DLNA system.

Recently, social networking sites are gradually popular to most users. Through the social networking sites, photo media files or video media files may be shared. For example, users may upload photo media files to the social networking sites to share the photo media files. Consequently, the purpose of sharing life or information is achieved. However, the functions of the social networking sites cannot be conveniently applied to the DLNA system. Generally, only the digital media player is able to be connected to the social networking site. After the digital media player is connected to the social networking site, the photo media files that are shared in the social networking site may be browsed by the user of the digital media player. Although the digital media renderers have a network connection function, most of the digital media renderers are not equipped with web browsers. In other words, through most of the digital media renderers, the social networking sites cannot be browsed by the user, and only few default websites can be browed. In some circumstances, few digital media renderers are equipped with web browsers, but these digital media renderers are too costly to be adopted by many users.

For example, when a user intends to play plural photo media files of a social networking site through a digital media renderer of the DLNA system to allow other users to view the photo media files collaboratively, the plural photo media files to be viewed should be firstly downloaded to a third-party device (e.g. a computer). After the plural photo media files are transmitted from the third-party device to the digital media server, the user may operate a digital media controller to control the digital media renderer to play the plural photo media files that are stored in the digital media server. In other words, the conventional DLNA system cannot be directly connected to the social networking site through network connection, and the shared photo media files in the social networking site cannot be directly browsed through the conventional DLNA system. For most users, the above operating method is inconvenient and troublesome.

Therefore, there is a need of providing a photo media playing system and a photo media playing method for playing photo media files of a social networking site in an area network.

### SUMMARY OF THE INVENTION

An object of the present invention provides a photo media playing method for playing photo media files of a social networking site in an area network.

Another object of the present invention provides a photo media playing system for playing photo media files of a social networking site in an area network.

In accordance with an aspect of the present invention, there is provided a photo media playing method for playing photo media files of a social networking site in an area network. The photo media playing method includes the following steps. Firstly, a first electronic device of an area network logins into a social networking site according to an account and a password corresponding to the social networking site. The first electronic device has a default virtual folder. The social networking site contains plural web albums. Each of the plural web albums contains plural photo media files. Then, the virtual folder is displayed on a second electronic device of the area network, and the virtual folder is selected. After the virtual folder is selected, a web album list corresponding to the plural web albums is retrieved from the social networking site to the first electronic device, and the web album list is transmitted from the first electronic device to the second electronic device. The web album list contains plural album names and is displayed on the second electronic device. Then, one of the plural album names of the web album list displayed on the second electronic device is selected. After the album name is selected, a photo media file list corresponding to the selected album name is retrieved from the social networking site to the first electronic device, and the photo media file list is transmitted from the first electronic device to the second electronic device. The photo media file list contains plural photo names. Then, plural media thumbnails corresponding to the plural photo names are retrieved from the social networking site to the first electronic device according to the photo media file list, and the plural media thumbnails are transmitted from the first electronic device to the second electronic device, so that the plural media thumbnails are displayed on the second electronic device. Then, one of the plural media thumbnails displayed on the second electronic device is displayed. After the media thumbnail is selected, the photo media file corresponding to the selected media thumbnail is retrieved from the social networking site to the first electronic device, and the photo media file is transmitted from the first electronic device to the area network, so that the photo media file is played by the second electronic device or a third electronic device of the area network.

In accordance with another aspect of the present invention, there is provided a photo media playing method for playing photo media files of a social networking site in an area network. The photo media playing method includes the following steps. Firstly, a first electronic device of an area network logins into a social networking site according to an account and a password corresponding to the social networking site. The social networking site contains plural web albums. Each of the plural web albums contains plural photo media files. After the first electronic device logins into the social networking site, the first electronic device retrieving a web album list corresponding to the social networking site, plural photo media file lists corresponding to the plural web albums and plural media thumbnails corresponding to the plural photo media files from the social networking site. The web album list contains plural album names corresponding to the plural web albums. Each of the plural photo media file lists contains plural photo names of the plural photo media files of the corresponding web album. Then, the web album list, the plural photo media file lists and the plural media thumbnails are stored into the first electronic device, and the social networking site is correlated with a virtual folder of the first electronic device. Then, the virtual folder is displayed on a second electronic device of the area network, and the virtual folder is selected. After the virtual folder is selected, the web album list is transmitted from the first electronic device to the second electronic device, and the plural album names are displayed on the second electronic device. Then, one of the plural album names of the web album list is selected. After the album name is selected, the photo media file list corresponding to the selected album name and the plural media thumbnails corresponding to the selected album name are transmitted from the first electronic device to the second electronic device, and the plural media thumbnails are displayed on the second electronic device. Then, one of the plural media thumbnails is selected. After the media thumbnail is selected, the photo media file corresponding to the selected media thumbnail is retrieved from the social networking site to the first electronic device, and the photo media file is transmitted from the first electronic device to the area network, so that the photo media file is played by the second electronic device or a third electronic device of the area network.

In accordance with a further aspect of the present invention, there is provided a photo media playing system. The photo media playing system includes a social networking site and an area network. The social networking site contains plural web albums. Each of the plural web albums contains plural photo media files. A web album list, plural photo media file lists, plural photo media files and plural media thumbnails corresponding to the plural photo media files are outputted from the social networking site. The web album list contains plural album names corresponding to the plural web albums. Each of the plural photo media file lists contains plural photo names corresponding to the plural photo media files. The area network is connected to the social networking site through network connection. The area network includes a network router, a digital media server, and an active control device. The network router is connected to the social networking site through network connection, and provides a network connection function. The digital media server is connected to the network router through network connection and connected to the social networking site via the network router through network connection. The digital media server logins into the social networking site according to an account and a password corresponding to the social networking site. Alternatively, the digital media server may receive the web album list, the plural photo media file lists, the plural media thumbnails and the plural photo media files, and may output the web album list, the plural photo media file lists, the plural media thumbnails and the plural photo media files. The active control device is connected to the network router through network connection and connected to the digital media server and the social networking site via the network router through network connection. The plural album names and the plural media thumbnails are selective through the active control device. After the plural media thumbnails are selected, the plural photo media files corresponding to the selected media thumbnails are requested from the digital media server by the active control device and the plural photo media files corresponding to the selected media thumbnails are requested from the social networking site by the digital media server, so that the plural photo media files are transmitted from the social networking site to the digital media server and the plural photo media files are outputted from the digital media server. After the plural photo media files are outputted from the digital media server, the plural photo media files are acquired and played by one of the active control device and a digital media renderer of the area network.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a first conventional DLNA system;

FIG. 2 schematically illustrates the architecture of a second conventional DLNA system;

FIG. 3 schematically illustrates the architecture of a third conventional DLNA system;

FIG. 4 is a schematic functional block diagram illustrating a photo media playing system according to a first embodiment of the present invention;

FIG. 5 schematically illustrates the photo media architecture of the social networking site of the photo media playing system according to the first embodiment of the present invention;

FIG. 6 is a flowchart illustrating a photo media playing method implemented by the photo media playing system according to the first embodiment of the present invention;

FIG. 7 is a flowchart illustrating the step A of the photo media playing method according to the embodiment of the present invention;

FIG. 8 schematically illustrates a login interface of the photo media playing system according to the first embodiment of the present invention;

FIG. 9 is a table indicating the metadata of the photo media playing system according to the embodiment of the present invention;

FIG. 10 is a schematic functional block diagram illustrating a photo media playing system according to a second embodiment of the present invention;

FIG. 11 is a schematic functional block diagram illustrating a photo media playing system according to a third embodiment of the present invention;

FIG. 12 is a flowchart illustrating a photo media playing method implemented by the photo media playing system according to the third embodiment of the present invention; and

FIG. 13 is a schematic functional block diagram illustrating a photo media playing system according to a fourth embodiment of the present invention.

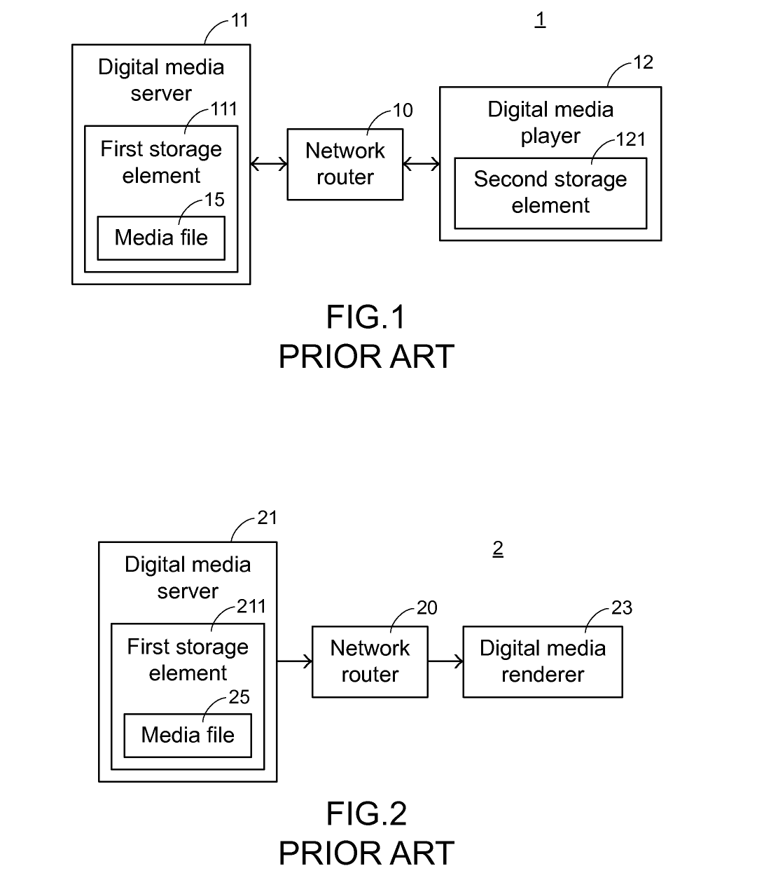

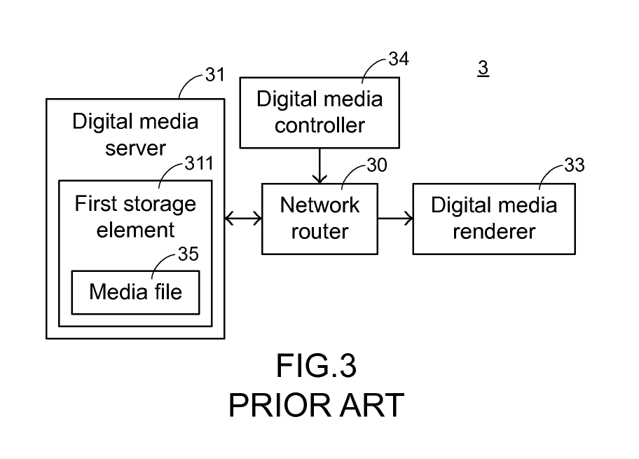

### DETAILED DESCRIPTION OF THE PREFERRED EMBODIMENT

For obviating the drawbacks of the prior art technologies, the present invention provides a photo media playing method for playing photo media files of a social networking site in an area network and a photo media playing system for implementing the photo media playing method of the present invention.

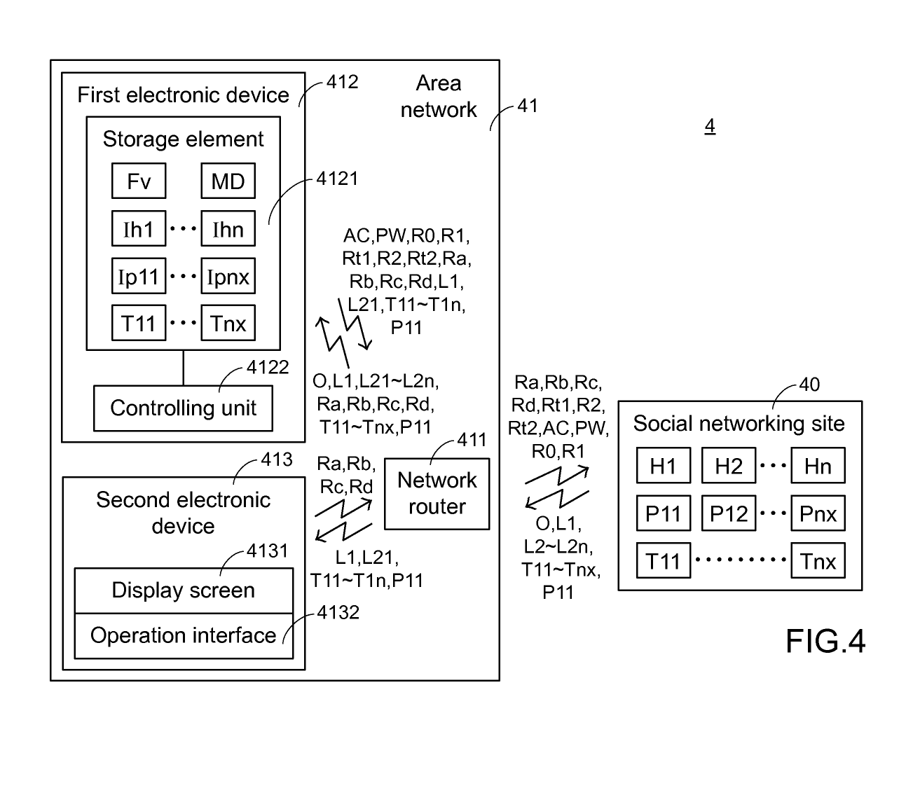

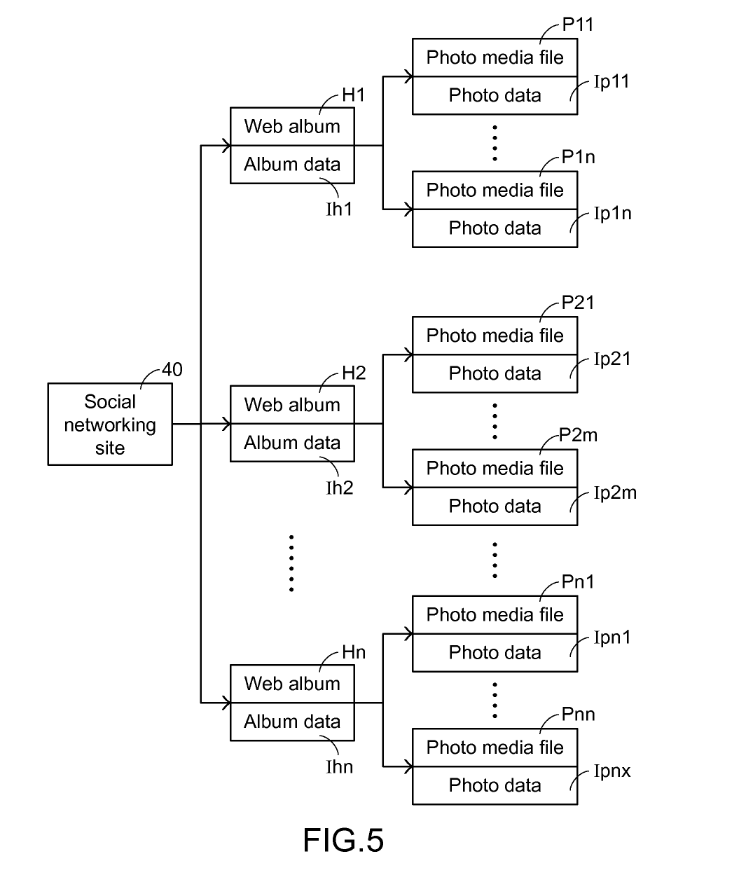

Hereinafter, a photo media playing system of the present invention will be illustrated with reference to FIGS. 4 and 5. FIG. 4 is a schematic functional block diagram illustrating a photo media playing system according to a first embodiment of the present invention. FIG. 5 schematically illustrates the photo media architecture of the social networking site of the photo media playing system according to the first embodiment of the present invention. As shown in FIGS. 4 and 5, the photo media playing system 4 comprises a social networking site 40 and an area network 41. The social networking site 40 comprises plural web albums H1˜Hn. The web album H1 of the plural web albums contains plural photo media files P11˜P1n. The web album H2 of the plural web albums contains plural photo media files P21˜P2m. The web album Hn of the plural web albums contains plural photo media files Pn1˜Pnx. The rest may be deduced by analogy. As shown in FIG. 5, the plural web albums H1˜Hn and the plural photo media files P11˜Pnx in the social networking site 40 are arranged in a hierarchical architecture. The social networking site 40 is in the first level of the hierarchical architecture; the plural web albums H1˜Hn are in the second level of the hierarchical architecture; and the plural photo media files P11˜Pnx are in the third level of the hierarchical architecture. In an embodiment, the social networking site 40 is the website “Facebook” or the website “Flickr”.

As shown in FIG. 4, the area network 41 comprises a network router 411, a first electronic device 412, and a second electronic device 413. The network router 411 is used to provide a network connection function. The first electronic device 412 and the second electronic device 413 are connected with each other via the network router 411 through network connection. Moreover, the first electronic device 412 and the second electronic device 413 are connected to the social networking site 40 via the network router 411 through network connection. The first electronic device 412 is connected to the network router 411 through network connection. Moreover, the first electronic device 412 is connected to the second electronic device 413 and the social networking site 40 via the network router 411 through network connection. Consequently, the data (e.g. the plural photo media files) from the social networking site 40 may be received by and stored into the first electronic device 412. The first electronic device 412 comprises a storage element 4121 and a controlling unit 4122. The storage element 4121 is included in the first electronic device 412 for storing these data. The controlling unit 4122 is connected to the storage element 4121. The controlling unit 4122 has two functions. Firstly, the controlling unit 4122 may receive an account AC and a password PW corresponding to the social networking site 40. According to the account AC and the password PW, the first electronic device 412 may login into the social networking site 40. Secondly, according to these data from the social networking site 40, a virtual folder Fv corresponding to the social networking site 40 is created by the controlling unit 4122. The method of allowing the first electronic device 412 to login into the social networking site 40 and these data provided by the social networking site 40 will be illustrated in more details later. In this embodiment, the first electronic device 412 is a digital media server, the storage element 4121 is a hard disc, and the controlling unit 4122 is a microprocessor.

The second electronic device 413 is connected to the network router 411 through network connection. Moreover, the second electronic device 413 is connected to the first electronic device 412 and the social networking site 40 via the network router 411 through network connection. When the second electronic device 413 is connected to the first electronic device 412 through network connection, the virtual folder Fv is displayed on the second electronic device 413, and the virtual folder Fv may be selected by the user. Consequently, the plural web albums H1˜Hn of the social networking site 40 corresponding to the virtual folder Fv and the detailed contents of these web albums may be viewed by the user through the second electronic device 413. The second electronic device 413 comprises a display screen 4131 and an operation interface 4132. The virtual folder Fv and the architecture of the plural web albums H1˜Hn of the social networking site 40 may be displayed on the display screen 4131. Via the operation interface 4132, the user may operate the virtual folder Fv and the architecture of the social networking site 40 in order to generate corresponding operation commands. In this embodiment, the second electronic device 413 is an active control device such as a digital media player (e.g. a smart phone). Moreover, the network router 411 complies with the universal plug and play (UPnP) protocol. Moreover, both of the first electronic device 412 and the second electronic device 413 comply with the Digital Living Network Alliance (DLNA) protocol.

The details contents of the data provided by the social networking site 40 will be illustrated as follows. When the first electronic device 412 of the photo media playing system 4 is connected to the social networking site 40 through network connection, the social networking site 40 issues a web album list L1, plural photo media file lists L21˜L2n and plural media thumbnails T11˜T1n, T21, . . . , and Tnx to the first electronic device 412 according to the requirements of the first electronic device 412. The web album list L1 contains plural album data Ih1˜Ihn corresponding to the plural web albums H1˜Hn. The photo media file list L21 contains plural photo data Ip11˜Ip1n corresponding to the plural photo media files P11˜P1n of the web album H1. The photo media file list L22 contains plural photo data Ip21˜Ip2m corresponding to the plural photo media files P21˜P2m of the web album H2. The photo media file list L2n contains plural photo data Ipn1˜Ipnx corresponding to the plural photo media files Pn1˜Pnx of the web album Hn. The rest may be deduced by analogy. All of the plural album data Ih1˜Ihn contain corresponding album names, corresponding album identities, corresponding album kinships and corresponding album types. In addition, all of the photo data Ipn1˜Ipnx contain corresponding photo names, corresponding photo identities, corresponding photo kinships and corresponding photo types.

After the web album list L1 and the plural photo media file lists L21˜L2n are received by the first electronic device 412, the user may allow the second electronic device 413 to be connected to the first electronic device 412 through network connection. In addition, when the plural album names contained in the plural album data Ih1˜Ihn are viewed by the user through the second electronic device 413, the user may realize that the plural web albums H1˜Hn are contained in the area network 41. Similarly, when the plural photo names contained in the plural photo data Ipn1˜Ipnx are viewed by the user through the second electronic device 413, the user may realize that the plural photo media files P11˜Pnx are contained in the area network 41.

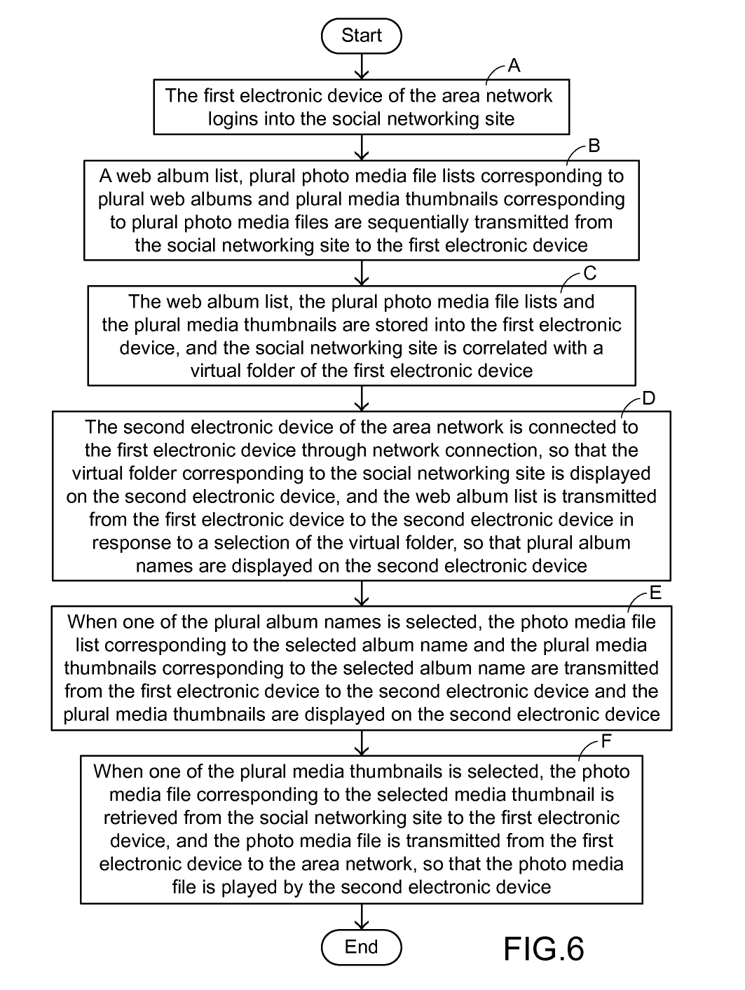

Hereinafter, a photo media playing method for playing photo media files of a social networking site in an area network according to the present invention will be illustrated with reference to FIG. 6. FIG. 6 is a flowchart illustrating a photo media playing method implemented by the photo media playing system according to the first embodiment of the present invention. The photo media playing method comprises the following steps.

Firstly, in a step A, the first electronic device of the area network logins into the social networking site. In a step B, a web album list, plural photo media file lists corresponding to plural web albums and plural media thumbnails corresponding to plural photo media files are sequentially transmitted from the social networking site to the first electronic device. In a step C, the web album list, the plural photo media file lists and the plural media thumbnails are stored into the first electronic device, and the social networking site is correlated with a virtual folder of the first electronic device. In a step D, the second electronic device of the area network is connected to the first electronic device through network connection, so that the virtual folder corresponding to the social networking site is displayed on the second electronic device, and the web album list is transmitted from the first electronic device to the second electronic device in response to a selection of the virtual folder, so that plural album names are displayed on the second electronic device. In a step E, when one of the plural album names is selected, the photo media file list corresponding to the selected album name and the plural media thumbnails corresponding to the selected album name are transmitted from the first electronic device to the second electronic device and the plural media thumbnails are displayed on the second electronic device. In a step F, when one of the plural media thumbnails is selected, the photo media file corresponding to the selected media thumbnail is retrieved from the social networking site to the first electronic device, and the photo media file is transmitted to the area network, so that the photo media file is played by the second electronic device.

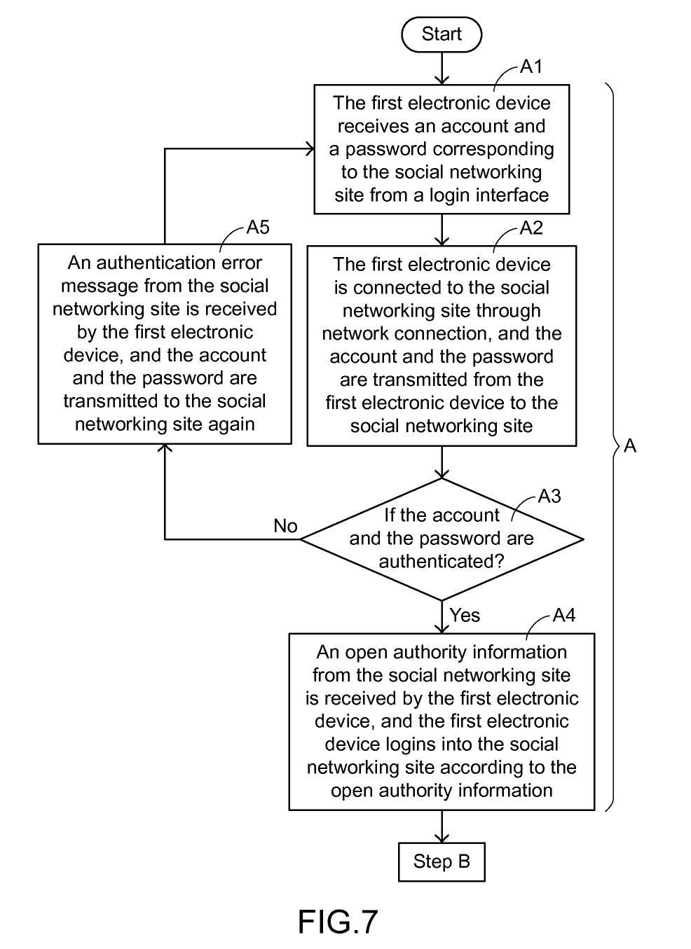

Hereinafter, the detailed procedures of the step A of the photo media playing method of the present invention will be illustrated with reference to FIG. 7. FIG. 7 is a flowchart illustrating the step A of the photo media playing method according to the embodiment of the present invention. The step A comprises the following sub-steps A1˜A5.

In the sub-step A1, the first electronic device receives an account and a password corresponding to the social networking site from a login interface. In the sub-step A2, the first electronic device is connected to the social networking site through network connection, and the account and the password are transmitted from the first electronic device to the social networking site. In the sub-step A3, the social networking site judges whether the account and the password are authenticated or not, and an authentication result corresponding to the account and the password is transmitted from the social networking site to the first electronic device. In the sub-step A4, if the authentication result indicates that the account and the password are authenticated, an open authority information from the social networking site is received by the first electronic device, and the first electronic device logins into the social networking site according to the open authority information. In the sub-step A5, if the authentication result indicates that the account and the password are not authenticated, an authentication error message from the social networking site is received by the first electronic device, and the account and the password are transmitted to the social networking site again.

The detailed procedures of the step C of the photo media playing method of the present invention will be illustrated as follows. The step C comprises the following sub-steps C1˜C4.

In the sub-step C1, plural album identities, plural album kinships and plural album types corresponding to the plural web albums and plural photo identities, plural photo kinships and plural photo types corresponding to the plural photo media files are acquired by the first electronic device according to the web album list and the plural photo media file lists. In the sub-step C2, the plural album identities, the plural album kinships, the plural album types, the plural photo identities, the plural photo kinships and the plural photo types are written into a metadata corresponding to the social networking site by the first electronic device, and the metadata into is stored into the first electronic device. In the sub-step C3, a virtual folder is created in the first electronic device. In the sub-step C4, the social networking site is correlated with the virtual folder according to the plural album identities, the plural album kinships, the plural album types, the plural photo identities, the plural photo kinships and the plural photo types.

The metadata of the of the social networking site describes the data property information in order to indicate the storage location, the history data, the resource search, the file record or any other appropriate information. In other words, the metadata is an electronic list for achieving a list editing function. The metadata describes the contents or the features of the web albums and the photo media files in order to facilitate searching the media data.

The detailed procedures of the step E of the photo media playing method of the present invention will be illustrated as follows. The step E comprises the following sub-steps E1 and E2.

In the sub-step E1, in response to a retrieve request corresponding to the selected album name and from the second electronic device, the photo media file list corresponding to the selected album name is transmitted from the first electronic device to the second electronic device. In the sub-step E2, in response to a retrieve request corresponding to the photo media file list and from the second electronic device, the plural media thumbnails corresponding to the selected album name are transmitted from the first electronic device to the second electronic device.

The detailed procedures of the step F of the photo media playing method of the present invention will be illustrated as follows. The step F comprises the following sub-steps F1˜F3.

In the sub-step F1, in response to a retrieve request corresponding to the selected media thumbnail and from the second electronic device, the photo media file corresponding to the selected media thumbnail is retrieved from the social networking site to the first electronic device. In the sub-step F2, the photo media file corresponding to the selected media thumbnail and from the social networking site is received by the first electronic device. In the sub-step F3, the photo media file is transmitted from the first electronic device to the second electronic device, and the photo media file is played by the second electronic device.

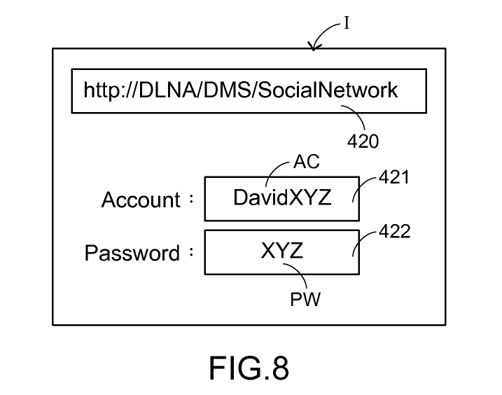

Hereinafter, the detailed procedure of the photo media playing method performed by the photo media playing system 4 will be illustrated with reference to FIGS. 4˜7 and FIG. 8. FIG. 8 schematically illustrates a login interface of the photo media playing system according to the first embodiment of the present invention. Firstly, the user may operate a third-party device (not shown) to open the login interface I through the internet. For example, the third-party device is a computer. As shown in FIG. 8, the login interface I contains a website address bar 420, an input account field 421 and an input password field 422. By operating the third-party device to input a website address corresponding to the first electronic device 412 (e.g. http://DLNA/DMS/SocialNetwork), the third-party device is connected to the login interface I, which is provided by the first electronic device 412. In addition, the website address http://DLNA/DMS/SocialNetwork is shown in the website address bar 420. Via the login interface I, the account AC may be keyed into the input account field 421, and the password PW may be keyed into the input password field 422. Consequently, the account AC and the password PW may be inputted by the user via the login interface. In addition, the account AC and the password PW are transmitted to the first electronic device 412. That is, the sub-step A1 is performed. Then, the first electronic device 412 is connected to the social networking site 40 via the network router 411 through network connection, and the account AC and the password PW are transmitted from the first electronic device 412 to the social networking site 40. That is, the sub-step A2 is performed.

After the account AC and the password PW are received by the social networking site 40, the social networking site 40 judges whether the account AC is authenticated by comparing the account AC with a predetermined account, and the social networking site 40 judges whether the password PW is authenticated by comparing the password PW with a predetermined password. That is, the sub-step A3 is performed. If the account AC complies with the predetermined account and the password PW complies with the predetermined password, the social networking site 40 judges that the account AC and the password PW are authenticated. Under this circumstance, an open authority information O is transmitted from the social networking site 40 to the first electronic device 412. After the open authority information O is stored in the storage element 4121 of the first electronic device 412, the first electronic device 412 may login into the social networking site 40 according to the open authority information O. That is, the sub-step A4 is performed. Meanwhile, the network connection between the first electronic device 412 and the social networking site 40 is established. In the step A3, if the social networking site 40 judges that the account AC and the password PW are not authenticated, the sub-step A5 is performed. That is, an authentication error message (not shown) is transmitted from the social networking site 40 to the first electronic device 412 to notify the user that the account AC or the password PW is erroneously inputted. Consequently, the user may input the accurate account AC and the accurate password PW in the next time. After the sub-step A5 is performed, the sub-step A1 is performed again.

In an embodiment, the open authority information O is provided from a specified website (e.g. the social networking site 40) to a specified electronic device. Consequently, according to the open authority information O, the user may browse the specified website through the electronic device without the need of inputting the account and the password. For example, the open authority information O is OAuth. The technical contents of OAuth are well known to those skilled in the art, and are not redundantly described herein.

After the first electronic device 412 logins into the social networking site 40, a data retrieve request R0 is transmitted from the first electronic device 412 to the social networking site 40 through the network router 411. After the data retrieve request R0 is received by the social networking site 40, the web album list L1 is transmitted from the social networking site 40 to the first electronic device 412. Consequently, according to the plural album data Ih1˜Ihn corresponding to the plural web albums H1˜Hn contained in the web album list L1, the first electronic device 412 realizes that the social networking site 40 contains the plural web albums H1˜Hn. Next, a data retrieve request R1 corresponding to the web album H1 is transmitted from the first electronic device 412 to the social networking site 40. In response to the data retrieve request R1, the photo media file list L21 is transmitted from the social networking site 40 to the first electronic device 412. The photo media file list L21 contains the plural photo data Ip11˜Ip1n corresponding to the web album H1. Consequently, according to the plural photo data Ip11˜Ip1n contained in the photo media file list L21, the first electronic device 412 realizes that the social networking site 40 contains the plural photo media files P11˜P1n corresponding to the plural photo data Ip11˜Ip1n.

Then, a thumbnail retrieve request Rt1 corresponding to the plural photo media files P11˜P1n is transmitted from the first electronic device 412 to the social networking site 40. In response to the thumbnail retrieve request Rt1, the plural media thumbnails T11˜T1n corresponding to the plural photo media files P11˜P1n are transmitted from the social networking site 40 to the first electronic device 412. The procedures of acquiring the plural web albums H1˜Hn, the plural photo data Ip11˜Ip1n corresponding to the web album H1 and the plural media thumbnails T11˜T1n by the first electronic device 412 have been mentioned above.

The procedures of acquiring the plural photo data Ip21˜Ip2m corresponding to the web album H2 and the plural media thumbnails T21˜T2m by the first electronic device 412 will be illustrated as follows. A data retrieve request R2 corresponding to the web album H2 is transmitted from the first electronic device 412 to the social networking site 40. In response to the data retrieve request R2, the photo media file list L22 is transmitted from the social networking site 40 to the first electronic device 412. The photo media file list L22 contains the plural photo data Ip21˜Ip2m corresponding to the web album H2. Consequently, according to the plural photo data Ip21˜Ip2m contained in the photo media file list L22, the first electronic device 412 realizes that the social networking site 40 contains the plural photo media files P21˜P2m corresponding to the plural photo data Ip21˜Ip2m.

Then, a thumbnail retrieve request Rt2 corresponding to the plural photo media files P21˜P2m is transmitted from the first electronic device 412 to the social networking site 40. In response to the thumbnail retrieve request Rt2, the plural media thumbnails T21˜T2m corresponding to the plural photo media files P21˜P2m are transmitted from the social networking site 40 to the first electronic device 412. After the above procedures are repeatedly performed to receive the photo media file list L22˜L2n from the social networking site 40, the plural album data Ih1˜Ihn, the plural photo data Ip11˜Ipnx corresponding to the plural web albums H1˜Hn and the plural media thumbnails T11˜Tnx are acquired by the first electronic device 412. That is, the step B is completed.

Then, the plural album data Ih1˜Ihn contained in the web album list L1, the plural photo data Ip11˜Ipnx contained in the plural photo media file lists L21˜L2n and the plural media thumbnails T11˜Tnx are stored into the storage element 4121 of the first electronic device 412. That is, the sub-step C1 is performed. Then, the plural album identities, the plural album kinships, the plural album types, the plural photo identities, the plural photo kinships and the plural photo types are written into a metadata MD corresponding to the social networking site 40 by the controlling unit 4122, and the metadata MD is stored into the storage element 4121 in order to record the arrangement of the hierarchical architecture of the social networking site 40. That is, the sub-step C2 is performed.

Then, a virtual folder Fv is created in the storage element 4121 by the controlling unit 4122. That is, the sub-step C3 is performed. Then, the social networking site 40 is correlated with the virtual folder Fv according to the plural album identities, the plural album kinships, the plural album types, the plural photo identities, the plural photo kinships and the plural photo types. That is, the sub-step C4 is performed. In this embodiment, all of the plural album data Ih1˜Ihn contains album character data corresponding to the social networking site 40, and all of the plural photo data Ip11˜Ip1n contain photo character data corresponding to the social networking site 40. Consequently, according to the album character data and the photo character data, the social networking site 40 is correlated with the virtual folder Fv by the controlling unit 4122.

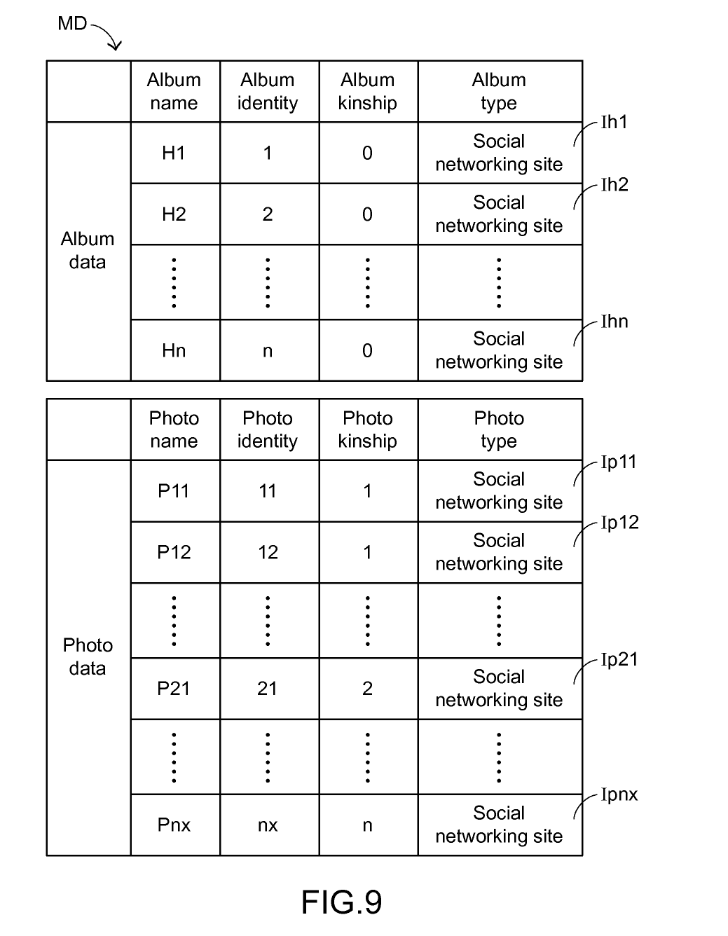

The following three aspects should be specially described. Firstly, all of the plural album data Ih1˜Ihn contain the corresponding album names, the corresponding album identities and the corresponding kinships. For example, the album name corresponding to the album data Ih1 is the web album H1 (e.g. a Profile Picture album). The album identity denotes the identification information of the web album H1 in the social networking site 40. The album identity corresponding to the album data Ih1 is 1. The album kinship corresponding to the album data Ih1 is 0. Moreover, the album identity for defining the root directory of the social networking site 40 is 0. The contents of the metadata MD are shown in FIG. 9. Similarly, the album name corresponding to the album data Ih2 is the web album H2 (e.g. a Mobile Uploads album). The album identity corresponding to the album data Ih2 is 2, which is different from the album identity of the web album H1. The album kinship corresponding to the album data Ih2 is also 0. Consequently, the social networking site 40 is in the first level of the root directory. According to the album kinships, the web album H1 and the web album H2 are in the second level of the root directory. The rest may be deduced by analogy.

Secondly, the contents of the plural photo data Ip11˜Ipnx are similar to the contents of the plural album data Ih1˜Ihn. That is, all of the plural photo data Ip11˜Ipnx contain the corresponding photo names, the corresponding photo identities and the corresponding photo kinships. For example, the photo name corresponding to the photo data Ip11 is the photo media file P11 (e.g. 01.JPG). The photo identity corresponding to the photo data Ip11 is 11, which denotes the identification information of the photo media file P11 in the social networking site 40. The photo kinship corresponding to the photo data Ip11 is 1. In other words, the photo media file P11 is contained in the web album H1. Moreover, the photo media file P11 is in the third level of the root directory (see FIG. 9). Consequently, according to the corresponding photo identity and the corresponding photo kinship, the controlling unit 4122 may realize that the photo media file P11 is contained in the web album H1 and the photo media file P11 is in the next level of the web album H1. According to the photo identities and the photo kinships corresponding to the remaining photo data Ip12˜Ipnx, the controlling unit 4122 may realize the similar results, which are not redundantly described herein. In other words, the controlling unit 4122 may store the entire hierarchical architecture of the social networking site 40 according to the plural album data Ih1˜Ihn and the plural photo data Ip11˜Ipnx.

Thirdly, the plural media thumbnails T11˜Tnx correspond to the plural photo media files P11˜Pnx, respectively. For example, the media thumbnail T11 is the reduced-size picture of the photo media file P11. The size of the photo media file P11 is much larger than the media thumbnail T11. Consequently, the way of storing the plural media thumbnails T11˜Tnx in the storage element 4121 may save the storage capacity of the storage element 4121. Moreover, since the sizes of the plural media thumbnails T11˜Tnx are smaller than the sizes of the plural photo media files P11˜Pnx, the transmission speed can be increased. Moreover, both of the media thumbnail T11 and the photo media file P11 correspond to the same photo data Ip11.

After the step C is completed, the second electronic device 413 is connected to the first electronic device 412 via the network router 411 through network connection. Consequently, the virtual folder Fv correlated with the social networking site 40 is displayed on the display screen 4131 of the second electronic device 413. That is, the step D is performed. Then, in the step E, the virtual folder Fv is selected by the user via the operation interface 4132 of the second electronic device 413. Consequently, the second electronic device 413 issues a web album retrieve request Ra to the first electronic device 412. In response to the web album retrieve request Ra, the web album list L1 is transmitted from the first electronic device 412 to the second electronic device 413. Consequently, the plural album names corresponding to the plural web albums H1˜Hn are displayed on the display screen 4131 of the second electronic device 413.

Please refer to FIGS. 4, 5 and 6 again. In the sub-step E1, the album name of the plural album names corresponding to the album data Ih1 is selected by the user via the operation interface 4132 of the second electronic device 413. Consequently, the second electronic device 413 issues a photo media retrieve request Rb corresponding to the album data Ih1 to the first electronic device 412. In response to the photo media retrieve request Rb, the photo media file list L21 corresponding to the album data Ih1 is transmitted from the controlling unit 4122 to the second electronic device 413. The photo media file list L21 contains the plural photo data Ip11˜Ip1n corresponding to the web album H1.

In the sub-step E2, according to the plural photo data Ip11˜Ip1n of the photo media file list L21, the second electronic device 413 issues a thumbnail retrieve request Rc corresponding to the photo media file list L21 to the first electronic device 412 via the network router 411. In response to the thumbnail retrieve request Rc, the plural media thumbnails T11˜T1n corresponding to the plural photo media files P11˜P1n are transmitted from the first electronic device 412 to the second electronic device 413. In addition, the plural media thumbnails T11˜T1n are displayed on the display screen 4131 of the second electronic device 413.

In the sub-step F1, the media thumbnail T11 is selected by the user via the operation interface 4132 of the second electronic device 413. Consequently, a photo media retrieve request Rd corresponding to the media thumbnail T11 is transmitted from the second electronic device 413 to the first electronic device 412, and the photo media retrieve request Rd is transmitted from the first electronic device 412 to the social networking site 40. In response to the photo media retrieve request Rd, the photo media file P11 corresponding to the photo data Ip11 and the media thumbnail T11 is transmitted from the social networking site 40 to the first electronic device 412. That is, the sub-step F2 is performed. Afterwards, the photo media file P11 is transmitted from the first electronic device 412 to the second electronic device 413, and the photo media file P11 is played by the display screen 4131 of the second electronic device 413. That is, the sub-step F3 is performed. Meanwhile, the method for playing photo media files of the social networking site in the area network is completed. The procedures of playing the photo media files P21˜Pnx corresponding to the web albums H2˜Hn are similar to the above procedures, and are not redundantly described herein.

Moreover, when the photo media file P11 is transmitted to the first electronic device 412 in the step F, the photo media file P11 is temporarily stored in the storage element 4121. After the photo media file P11 is transmitted from the first electronic device 412 to the second electronic device 413, the photo media file P11 that is temporarily stored in the storage element 4121 is deleted by the controlling unit 4122. Consequently, the storage capacity of the storage element 4121 will be enhanced.

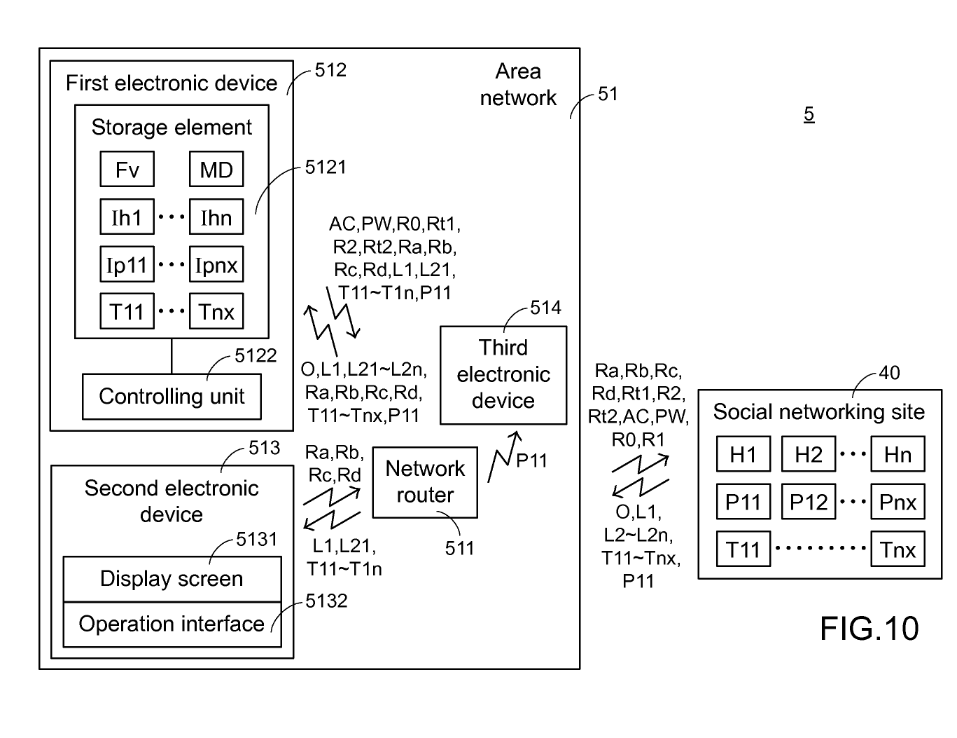

The present invention further provides a second embodiment, which is distinguished from the first embodiment. FIG. 10 is a schematic functional block diagram illustrating a photo media playing system according to a second embodiment of the present invention. As shown in FIG. 10, the photo media playing system 5 comprises a social networking site 40 and an area network 51. The configurations and functions of the social networking site 40 are identical to those of the social networking site of the first embodiment, and are not redundantly described herein. As shown in FIG. 10, the area network 51 comprises a network router 511, a first electronic device 512, a second electronic device 513, and a third electronic device 514. The first electronic device 512 comprises a storage element 5121 and a controlling unit 5122. The second electronic device 513 comprises a display screen 5131 and an operation interface 5132. The third electronic device 514 is connected to the network router 511 through network connection. Moreover, the third electronic device 514 is connected to the second electronic device 513, the first electronic device 512 and the social networking site 40 via the network router 511 through network connection. In this embodiment, the second electronic device 513 is an active control device such as a digital media controller (e.g. a remote controller), and the second electronic device 513 does not have the function of playing the photo media files. Moreover, the third electronic device 514 is a digital media renderer (e.g. a television) for playing the photo media files.

The operations of the network router 511, the first electronic device 512 and the social networking site 40 are similar to those of the first embodiment, and are not redundantly described herein. In comparison with the first embodiment, the operations between the second electronic device 513 and the third electronic device 514 are distinguished. In other words, the steps A˜E of the photo media playing method of the first embodiment are also implemented by the photo media playing system 5 of this embodiment, but the step F to be implemented by the photo media playing system 5 is distinguished. In the step F, when one of the plural media thumbnails is selected, a photo media file corresponding to the selected media thumbnail is retrieved from the social networking site to the first electronic device, and the photo media file is transmitted to the area network, so that the photo media file is played by a third electronic device of the area network.

The detailed procedures of the step F of this embodiment will be illustrated as follows. The step F comprises the following sub-steps F4˜F6. In the sub-step F4, in response to a retrieve request corresponding to the selected media thumbnail and from the second electronic device, the photo media file corresponding to the selected media thumbnail is retrieved from the social networking site to the first electronic device. In the sub-step F5, the first electronic device receives the photo media file corresponding to the selected media thumbnail from the social networking site is received by. In the sub-step F6, the photo media file is transmitted from the first electronic device to the third electronic device, and the photo media file is played by the third electronic device.

After the steps A˜E of the photo media playing method of the first embodiment are implemented by the photo media playing system 5, the following procedures are performed. In the sub-step F4, the media thumbnail T11 is selected by the user via the operation interface 5132 of the second electronic device 513. Consequently, a photo media retrieve request Rd corresponding to the media thumbnail T11 is transmitted from the second electronic device 513 to the first electronic device 512, and the photo media retrieve request Rd is transmitted from the first electronic device 512 to the social networking site 40. In response to the photo media retrieve request Rd, the photo media file P11 corresponding to the photo data Ip11 and the media thumbnail T11 is transmitted from the social networking site 40 to the first electronic device 512. That is, the sub-step F5 is performed. Afterwards, the photo media file P11 is transmitted from the first electronic device 512 to the third electronic device 514, and the photo media file P11 is played by third electronic device 514. That is, the sub-step F6 is performed. Consequently, the plural photo media files P11˜Pnx of the social networking site 40 may be collaboratively browsed by the user and other users through the third electronic device 514.

That is, in addition to the use of the digital media player to play the photo media file, the photo media playing system of the present invention may use the digital media renderer to play the photo media file. Consequently, the plural photo media files of the social networking site may be collaboratively browsed by plural users.

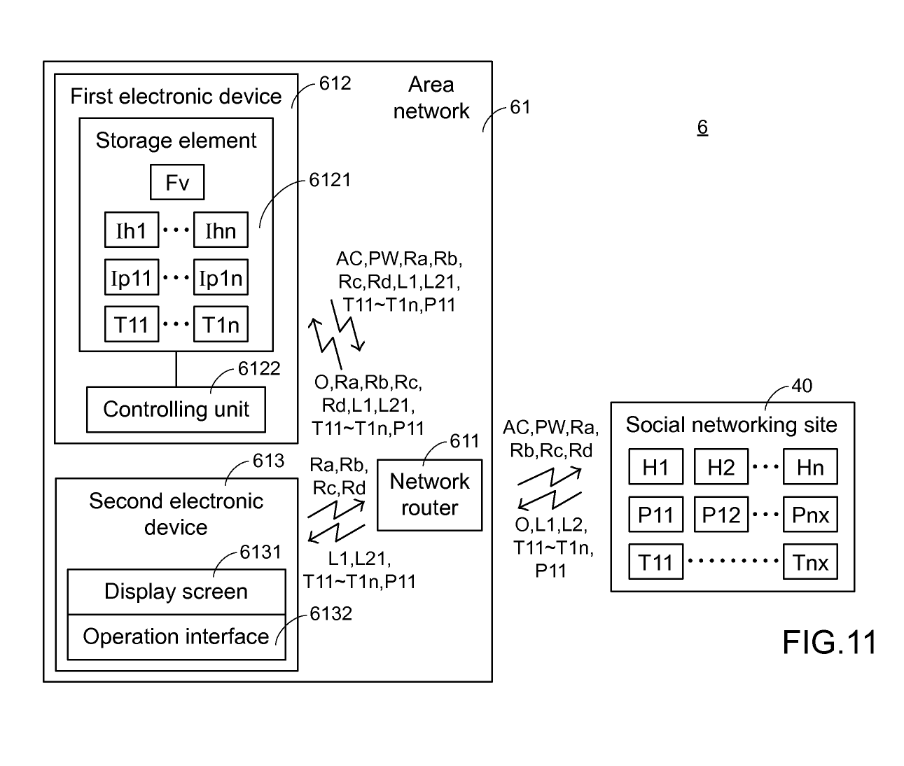

The present invention further provides a third embodiment, which is distinguished from the first embodiment. Please refer to FIGS. 5 and 11. FIG. 11 is a schematic functional block diagram illustrating a photo media playing system according to a third embodiment of the present invention. The photo media playing system 6 comprises a social networking site 40 and an area network 61. The configurations and functions of the social networking site 40 are identical to those of the social networking site of the first embodiment, and are not redundantly described herein. The area network 61 comprises a network router 611, a first electronic device 612 and a second electronic device 613. The first electronic device 612 comprises a storage element 6121 and a controlling unit 6122. The operations of the network router 611 and the second electronic device 613 are similar to those of the first embodiment, and are not redundantly described herein. In comparison with the first embodiment, the two aspects are distinguished. Firstly, the virtual folder Fv is a default virtual folder that is previously stored in the first electronic device 612. Before the web album list L1 is acquired by the first electronic device 612, the contents of the virtual folder Fv are void. Secondly, the operations between the first electronic device 612 and the social networking site 40 are distinguished. In other words, the photo media playing method of this embodiment is distinguished from the photo media playing method of the first embodiment. The photo media playing method of this embodiment will be illustrated as follows.

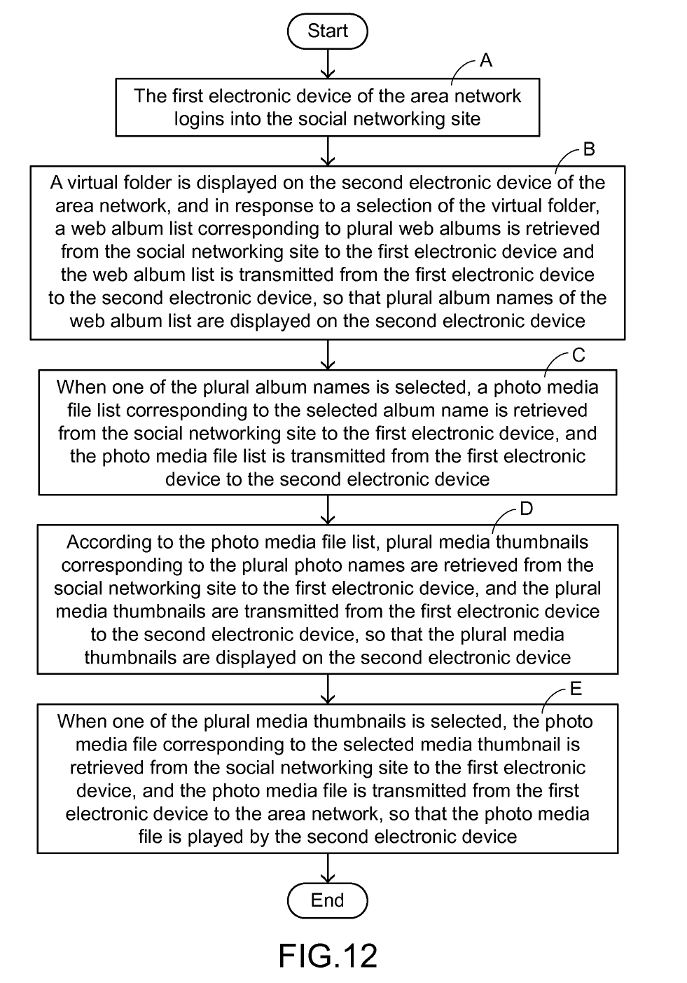

Hereinafter, a method for playing photo media files of a social networking site in an area network according to the present invention will be illustrated with reference to FIG. 12. FIG. 12 is a flowchart illustrating a photo media playing method implemented by the photo media playing system according to the third embodiment of the present invention. The photo media playing method comprises the following steps.

Firstly, in a step A, the first electronic device of the area network logins into the social networking site. In a step B, the virtual folder is displayed on the second electronic device of the area network, and in response to a selection of the virtual folder, a web album list corresponding to plural web albums is retrieved from the social networking site to the first electronic device and the web album list is transmitted from the first electronic device to the second electronic device, so that plural album names of the web album list are displayed on the second electronic device. In a step C, when one of the plural album names is selected, a photo media file list corresponding to the selected album name is retrieved from the social networking site to the first electronic device, and the photo media file list is transmitted from the first electronic device to the second electronic device. In a step D, according to the photo media file list, plural media thumbnails corresponding to the plural photo names are retrieved from the social networking site to the first electronic device, and the plural media thumbnails are transmitted from the first electronic device to the second electronic device, so that the plural media thumbnails are displayed on the second electronic device. In a step E, when one of the plural media thumbnails is selected, the photo media file corresponding to the selected media thumbnail is retrieved from the social networking site to the first electronic device, and the photo media file is transmitted from the first electronic device to the area network, so that the photo media file is played by the second electronic device.

The procedures of the step A of the photo media playing method of this embodiment is identical to the procedures of the step A of the photo media playing method of the first embodiment, and are not redundantly described herein.

Moreover, the step E comprises the following sub-steps E1˜E3. In the sub-step E1, in response to a retrieve request corresponding to the selected media thumbnail and from the second electronic device, the photo media file corresponding to the selected media thumbnail is retrieved from the social networking site to the first electronic device. In the sub-step E2, the first electronic device receives the photo media file corresponding to the selected media thumbnail from the social networking site. In the sub-step E3, the photo media file is transmitted from the first electronic device to the second electronic device, and the photo media file is played by the second electronic device.

The detailed procedure of the photo media playing method performed by the photo media playing system 6 will be illustrated as follows. Firstly, the photo media playing system 6 performs the step A, so that the first electronic device 612 logins into the social networking site 40. The procedures of the step A of the photo media playing method of this embodiment is identical to the procedures of the step A of the photo media playing method of the first embodiment, and are not redundantly described herein. Then, the step B is performed. When the second electronic device 613 is connected to the first electronic device 612 through network connection, the virtual folder Fv corresponding to the social networking site 40 is displayed on the second electronic device 613. Meanwhile, the contents of the virtual folder Fv are still void. In the step B, the virtual folder Fv is selected by the user via the operation interface 6132 of the second electronic device 613. Consequently, the second electronic device 613 issues a web album retrieve request Ra to the first electronic device 612. Since no photo media data about the social networking site 40 are stored in the storage element 6121, the web album retrieve request Ra is also transmitted from the first electronic device 612 to the social networking site 40. In response to the web album retrieve request Ra, a web album list L1 is transmitted from the social networking site 40 to the first electronic device 612, and the web album list L is temporarily stored in the storage element 6121. Then, the web album list L1 is transmitted from the first electronic device 612 to the second electronic device 613. Consequently, the plural album names of the web album list L1 are displayed on the display screen 6131 of the second electronic device 613. Meanwhile, the step B is completed.

The following two aspects should be specially described. Firstly, like the first embodiment, the web album list L1 contains plural album data Ih1˜Ihn corresponding to the plural web albums H1˜Hn, and the plural album names are contained in the plural album data Ih1˜Ihn. Secondly, after the web album list L1 is received by the second electronic device 613, the plural album data Ih1˜Ihn in the web album list L1 are deleted from the storage element 6121 of the first electronic device 612.

Please refer to FIGS. 11 and 12 again. In the sub-step C, one of the plural album names is selected by the user via the operation interface 6132 of the second electronic device 613. Consequently, the second electronic device 613 issues a photo media retrieve request Rb corresponding to the selected alum name to the first electronic device 612. The photo media retrieve request Rb is also transmitted from the first electronic device 612 to the social networking site 40. In response to the photo media retrieve request Rb, a photo media file list L21 corresponding to the album name is transmitted from the social networking site 40 to the first electronic device 612. The photo media file list L21 contains plural photo data Ip11˜Ip1n corresponding to the web album H1. In addition, the plural photo data Ip11˜Ip1n are temporarily stored in the storage element 6121. Then, the photo media file list L21 is also transmitted from the first electronic device 612 to the second electronic device 613. After the photo media file list L21 is received by the second electronic device 613, the plural photo data Ip11˜Ip1n in the photo media file list L21 are deleted from the storage element 6121 of the first electronic device 612.

In the step D, a thumbnail retrieve request Rc corresponding to plural photo names of the plural photo data Ip11˜Ip1n is transmitted from the second electronic device 613 to the first electronic device 612. The thumbnail retrieve request Rc is also transmitted from the first electronic device 612 to the social networking site 40. In response to the thumbnail retrieve request Rc, the plural media thumbnails T11˜T1n corresponding to the plural photo media files P11˜P1n are transmitted from the social networking site 40 to the first electronic device 612. In addition, the plural media thumbnails T11˜T1n are temporarily stored in the storage element 6121. Then, the plural media thumbnails T11˜T1n corresponding to the plural photo media files P11˜P1n are transmitted from the first electronic device 612 to the second electronic device 613, and the plural media thumbnails T11˜T1n are displayed on the display screen 6131 of the second electronic device 613. After the plural media thumbnails T11˜T1n are received by the second electronic device 613, the plural media thumbnails T11˜T1n are deleted from the storage element 6121 of the first electronic device 612.

In the sub-step E1, the media thumbnail T11 is selected by the user via the operation interface 6132 of the second electronic device 613. Consequently, a photo media retrieve request Rd corresponding to the media thumbnail T11 is transmitted from the second electronic device 613 to the first electronic device 612, and the photo media retrieve request Rd is transmitted from the first electronic device 612 to the social networking site 40. In response to the photo media retrieve request Rd, the photo media file P11 corresponding to the photo data Ip11 and the media thumbnail T11 is transmitted from the social networking site 40 to the first electronic device 612. In addition, the photo media file P11 is temporarily stored in the storage element 6121. That is, the sub-step E2 is performed. Afterwards, the photo media file P11 is transmitted from the first electronic device 612 to the second electronic device 613, and the photo media file P11 is played by the display screen 6131 of the second electronic device 613. That is, the sub-step E3 is performed. After the photo media file P11 is received by the second electronic device 613, the photo media file P11 is deleted from the storage element 6121 of the first electronic device 612. Consequently, the storage capacity of the storage element 6121 will be enhanced. Meanwhile, the method for playing photo media files of the social networking site in the area network is completed. The procedures of playing the photo media files P21˜Pnx corresponding to the web albums H2˜Hn are similar to the above procedures, and are not redundantly described herein.

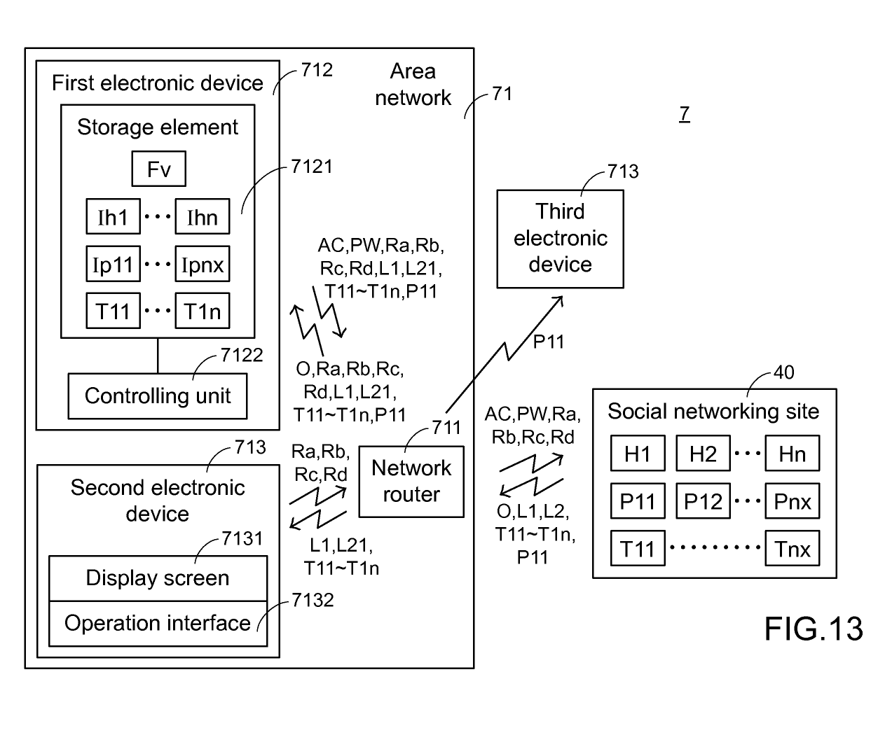

The present invention further provides a fourth embodiment, which is distinguished from the third embodiment. Please refer to FIGS. 5 and 13. FIG. 13 is a schematic functional block diagram illustrating a photo media playing system according to a fourth embodiment of the present invention. The photo media playing system 7 comprises a social networking site 40 and an area network 71. The configurations and functions of the social networking site 40 are identical to those of the social networking site of the first embodiment, and are not redundantly described herein. As shown in FIG. 13, the area network 71 comprises a network router 711, a first electronic device 712, a second electronic device 713, and a third electronic device 714. The first electronic device 712 comprises a storage element 7121 and a controlling unit 7122. The second electronic device 713 comprises a display screen 7131 and an operation interface 7132. The third electronic device 714 is connected to the network router 711 through network connection. Moreover, the third electronic device 714 is connected to the second electronic device 713, the first electronic device 712 and the social networking site 40 via the network router 711 through network connection. In this embodiment, the second electronic device 713 is an active control device such as a digital media controller, and the second electronic device 713 does not have the function of playing the photo media files. Moreover, the third electronic device 714 is a digital media renderer for playing the photo media files.

The operations of the network router 711, the first electronic device 712 and the social networking site 40 are similar to those of the third embodiment, and are not redundantly described herein. In comparison with the third embodiment, the operations between the second electronic device 713 and the third electronic device 714 are distinguished. In other words, the steps A˜D of the photo media playing method of the third embodiment are also implemented by the photo media playing system 7 of this embodiment, but the step E to be implemented by the photo media playing system 7 is distinguished.

In the step E, when the media thumbnail T11 is selected, the photo media file P11 corresponding to the media thumbnail T11 is transmitted from the social networking site 40 to the area network 71. Consequently, the photo media file P11 is played by third electronic device 714 of the area network 71.

The detailed procedures of the step E of this embodiment will be illustrated as follows. The step E comprises the following sub-steps E4˜E6. In the sub-step E4, in response to a retrieve request corresponding to the selected media thumbnail and from the second electronic device, the photo media file corresponding to the selected media thumbnail is retrieved from the social networking site to the first electronic device. In the sub-step E5, the first electronic device receives the photo media file corresponding to the selected media thumbnail from the social networking site. In the sub-step E6, the photo media file is transmitted from the first electronic device to the third electronic device, and the photo media file is played by the third electronic device.

After the steps A˜D of the photo media playing method of the first embodiment are implemented by the photo media playing system 7, the following procedures are performed. In the sub-step E4, the media thumbnail T11 is selected by the user via the operation interface 7132 of the second electronic device 713. Consequently, a photo media retrieve request Rd corresponding to the media thumbnail T11 is transmitted from the second electronic device 713 to the first electronic device 712, and the photo media retrieve request Rd is transmitted from the first electronic device 712 to the social networking site 40. In response to the photo media retrieve request Rd, the photo media file P11 corresponding to the media thumbnail T11 is transmitted from the social networking site 40 to the first electronic device 712. That is, the sub-step E5 is performed. Afterwards, the photo media file P11 is transmitted from the first electronic device 712 to the third electronic device 714, and the photo media file P11 is played by third electronic device 714. That is, the sub-step E6 is performed. Consequently, the plural photo media files P11˜Pnx of the social networking site 40 may be collaboratively browsed by the user and other users through the third electronic device 714.

That is, in addition to the use of the digital media player to play the photo media file, the photo media playing system of the present invention may use the digital media renderer to play the photo media file. Consequently, the plural photo media files of the social networking site may be collaboratively browsed by plural users.

From the above descriptions, the present invention provides a photo media playing system and a photo media playing method for playing plural photo media files of a social networking site in an area network. After a digital media server logins into the social networking site and the digital media server acts as the bridge between the area network and the social networking site, the plural photo media files of the social networking site are transmitted to a digital media renderer or a digital media player. Consequently, the plural photo media files are played by the digital media renderer or the digital media player, and the operating procedures are simplified. In case that the plural photo media files are played by the digital media renderer, the plural photo media files may be collaboratively viewed by many users. Moreover, after the digital media server logins into the social networking site through network connection, a web album list, plural photo media file lists and plural media thumbnails corresponding to the social networking site are stored in the digital media server. Consequently, when the user intends to browse the plural media thumbnails corresponding to the plural photo media files of the social networking site, the data transmission speed is increased and the waiting time is shortened by simply establishing the communication between the digital media server and the active control device.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A photo media playing method for playing photo media files of a social networking site in an area network, the photo media playing method comprising steps of:
(A) allowing a first electronic device of an area network to login into a social networking site according to an account and a password corresponding to the social networking site, wherein the first electronic device has a default virtual folder, and the social networking site contains plural web albums, wherein each of the plural web albums contains plural photo media files;
(B) displaying the virtual folder on a second electronic device of the area network, and selecting the virtual folder, wherein after the virtual folder is selected, a web album list corresponding to the plural web albums is retrieved from the social networking site to the first electronic device, and the web album list is transmitted from the first electronic device to the second electronic device, wherein the web album list contains plural album names and plural album names are displayed on the second electronic device;
(C) selecting one of the plural album names of the web album list, which is displayed on the second electronic device, wherein after the album name is selected, a photo media file list corresponding to the selected album name is retrieved from the social networking site to the first electronic device, and the photo media file list is transmitted from the first electronic device to the second electronic device, wherein the photo media file list contains plural photo names;
(D) retrieving plural media thumbnails corresponding to the plural photo names from the social networking site to the first electronic device according to the photo media file list, and transmitting the plural media thumbnails from the first electronic device to the second electronic device, so that the plural media thumbnails are displayed on the second electronic device; and
(E) selecting one of the plural media thumbnails, which are displayed on the second electronic device, wherein after the media thumbnail is selected, the photo media file corresponding to the selected media thumbnail is retrieved from the social networking site to the first electronic device, and the photo media file is transmitted from the first electronic device to the area network, so that the photo media file is played by the second electronic device or a third electronic device of the area network.

2. The photo media playing method according to claim 1, wherein the step (A) comprises sub-steps of:
(A1) the first electronic device receiving the account and the password from a login interface;
(A2) allowing the first electronic device to be connected to the social networking site through network connection, and transmitting the account and the password from the first electronic device to the social networking site;
(A3) selectively allowing the first electronic device to login into the social networking site or transmitting the account and the password to the social networking site again according to an authentication result from the social networking site and corresponding to the account and the password;
(A4) if the authentication result indicates that the account and the password are authenticated, allowing the first electronic device to receive an open authority information from the social networking site and allowing the first electronic device to login into the social networking site according to the open authority information; and
(A5) if the authentication result indicates that the account and the password are not authenticated, allowing the first electronic device to receive an authentication error message from the social networking site, and transmitting the account and the password from the first electronic device to the social networking site again.

3. The photo media playing method according to claim 1, wherein the step (E) comprises sub-steps of:
(E1) in response to a retrieve request corresponding to the selected media thumbnail and from the second electronic device, the first electronic device retrieving the photo media file corresponding to the selected media thumbnail from the social networking site;
(E2) the first electronic device receiving the photo media file corresponding to the selected media thumbnail from the social networking site; and
(E3) transmitting the photo media file from the first electronic device to the second electronic device, and playing the photo media file by the second electronic device, wherein the first electronic device is a digital media server according to a DLNA protocol, and the second electronic device is a digital media player according to the DLNA protocol.

4. The photo media playing method according to claim 1, wherein the step (E) comprises sub-steps of:
(E1) in response to a retrieve request corresponding to the selected media thumbnail and from the third electronic device, the first electronic device retrieving the photo media file corresponding to the selected media thumbnail from the social networking site;
(E2) the first electronic device receiving the photo media file corresponding to the selected media thumbnail from the social networking site; and
(E3) transmitting the photo media file from the first electronic device to the third electronic device, and playing the photo media file by the third electronic device, wherein the first electronic device is a digital media server according to a DLNA protocol, the second electronic device is a digital media player according to the DLNA protocol, and the third electronic device is a digital media renderer according to the DLNA protocol.

5. A photo media playing method for playing photo media files of a social networking site in an area network, the photo media playing method comprising steps of:
(A) allowing a first electronic device of an area network to login into a social networking site according to an account and a password corresponding to the social networking site, wherein the social networking site contains plural web albums, wherein each of the plural web albums contains plural photo media files;
(B) after the first electronic device logins into the social networking site, the first electronic device retrieving a web album list corresponding to the social networking site, plural photo media file lists corresponding to the plural web albums and plural media thumbnails corresponding to the plural photo media files from the social networking site, wherein the web album list contains plural album names corresponding to the plural web albums, and each of the plural photo media file lists contains plural photo names of the plural photo media files of the corresponding web album;
(C) storing the web album list, the plural photo media file lists and the plural media thumbnails into the first electronic device, and correlating the social networking site with a virtual folder of the first electronic device;
(D) displaying the virtual folder on a second electronic device of the area network, and selecting the virtual folder, wherein after the virtual folder is selected, the web album list is transmitted from the first electronic device to the second electronic device, and the plural album names are displayed on the second electronic device;
(E) selecting one of the plural album names of the web album list, wherein after the album name is selected, the photo media file list corresponding to the selected album name and the plural media thumbnails corresponding to the selected album name are transmitted from the first electronic device to the second electronic device, and the plural media thumbnails are displayed on the second electronic device; and
(F) selecting one of the plural media thumbnails, wherein after the media thumbnail is selected, the photo media file corresponding to the selected media thumbnail is retrieved from the social networking site to the first electronic device, and the photo media file is transmitted from the first electronic device to the area network, so that the photo media file is played by the second electronic device or a third electronic device of the area network.

6. The photo media playing method according to claim 5, wherein the step (A) comprises sub-steps of:
(A1) the first electronic device receiving the account and the password from a login interface;
(A2) allowing the first electronic device to be connected to the social networking site through network connection, and transmitting the account and the password from the first electronic device to the social networking site;
(A3) selectively allowing the first electronic device to login into the social networking site or transmitting the account and the password to the social networking site again according to an authentication result from the social networking site and corresponding to the account and the password;
(A4) if the authentication result indicates that the account and the password are authenticated, allowing the first electronic device to receive an open authority information from the social networking site and allowing the first electronic device to login into the social networking site according to the open authority information; and
(A5) if the authentication result indicates that the account and the password are not authenticated, allowing the first electronic device to receive an authentication error message from the social networking site, and transmitting the account and the password from the first electronic device to the social networking site again.

7. The photo media playing method according to claim 5, wherein the step (C) comprises sub-steps of:
(C1) the first electronic device retrieving plural album identities, plural album kinships and plural album types corresponding to the plural web albums and plural photo identities, plural photo kinships and plural photo types corresponding to the plural photo media files according to the web album list and the plural photo media file lists;
(C2) writing the plural album identities, the plural album kinships, the plural album types, the plural photo identities, the plural photo kinships and the plural photo types into a metadata corresponding to the social networking site by the first electronic device, and storing the metadata into the first electronic device;
(C3) creating the virtual folder in the first electronic device; and
(C4) correlating the social networking site with the virtual folder according to the plural album identities, the plural album kinships, the plural album types, the plural photo identities, the plural photo kinships and the plural photo types.

8. The photo media playing method according to claim 5, wherein the step (E) comprises sub-steps of:
(E1) in response to a retrieve request corresponding to the selected album name and from the second electronic device, transmitting the photo media file list corresponding to the selected album name from the first electronic device to the second electronic device; and
(E2) in response to a retrieve request corresponding to the photo media file list and from the second electronic device, transmitting the plural media thumbnails corresponding to the selected album name from the first electronic device to the second electronic device, and displaying the plural media thumbnails on the second electronic device.

9. The photo media playing method according to claim 5, wherein the step (F) comprises sub-steps of:
(F1) in response to a retrieve request corresponding to the selected media thumbnail and from the second electronic device, the first electronic device retrieving the photo media file corresponding to the selected media thumbnail from the social networking site;
(F2) the first electronic device receiving the photo media file corresponding to the selected media thumbnail from the social networking site; and
(F3) transmitting the photo media file from the first electronic device to the second electronic device, and playing the photo media file by the second electronic device, wherein the first electronic device is a digital media server according to a DLNA protocol, and the second electronic device is a digital media player according to the DLNA protocol.

10. The photo media playing method according to claim 5, wherein the step (F) comprises sub-steps of:
(F1) in response to a retrieve request corresponding to the selected media thumbnail and from the third electronic device, the first electronic device retrieving the photo media file corresponding to the selected media thumbnail from the social networking site;
(F2) the first electronic device receiving the photo media file corresponding to the selected media thumbnail from the social networking site; and
(F3) transmitting the photo media file from the first electronic device to the third electronic device, and playing the photo media file by the third electronic device, wherein the first electronic device is a digital media server according to a DLNA protocol, the second electronic device is a digital media player according to the DLNA protocol, and the third electronic device is a digital media renderer according to the DLNA protocol.

11. A photo media playing system, comprising:
a social networking site containing plural web albums, wherein each of the plural web albums contains plural photo media files, wherein a web album list, plural photo media file lists, plural photo media files and plural media thumbnails corresponding to the plural photo media files are outputted from the social networking site, wherein the web album list contains plural album names corresponding to the plural web albums, and each of the plural photo media file lists contains plural photo names corresponding to the plural photo media files; and
an area network connected to the social networking site through network connection, wherein the area network comprises:
a network router connected to the social networking site through network connection, and providing a network connection function;
a digital media server connected to the network router through network connection and connected to the social networking site via the network router through network connection, wherein the digital media server logins into the social networking site according to an account and a password corresponding to the social networking site, or the digital media server receives the web album list, the plural photo media file lists, the plural media thumbnails and the plural photo media files and outputs the web album list, the plural photo media file lists, the plural media thumbnails and the plural photo media files; and
an active control device connected to the network router through network connection and connected to the digital media server and the social networking site via the network router through network connection, wherein the plural album names and the plural media thumbnails are selective through the active control device, wherein after the plural media thumbnails are selected, the plural photo media files corresponding to the selected media thumbnails are requested from the digital media server by the active control device and the plural photo media files corresponding to the selected media thumbnails are requested from the social networking site by the digital media server, so that the plural photo media files are transmitted from the social networking site to the digital media server and the plural photo media files are outputted from the digital media server, wherein after the plural photo media files are outputted from the digital media server, the plural photo media files are acquired and played by one of the active control device and a digital media renderer of the area network.

12. The photo media playing system according to claim 11, wherein the account and the password corresponding to the social networking site are received by the digital media server through a login interface, wherein the login interface comprises and input account field and an input password field, wherein the account is keyed into the input account field, and the password is keyed into the input password field, wherein after the account and the password are transmitted from the login interface to the social networking site, the social networking site judges whether the account and the password are authenticated by comparing the account with a predetermined account and comparing the password with a predetermined password, wherein if the account complies with the predetermined account and the password complies with the predetermined password, the social networking site judges that the account and the password are authenticated, so that the digital media server logins into the social networking site.

13. The photo media playing system according to claim 11, wherein the digital media server comprises:
a storage element disposed within the digital media server, wherein the web album list, the plural photo media file lists, the plural media thumbnails and the plural photo media files are temporarily stored in the storage element; and
a controlling unit connected to the storage element, wherein the digital media server logins into the social networking site according to the account and the password after the account and the password corresponding to the social networking site are received by the controlling unit, or a virtual folder corresponding to the social networking site is created by the controlling unit according to plural album identities, plural album kinships and plural album types of the web album list and plural photo identities, plural photo kinships and plural photo types of the plural photo media file lists corresponding to the plural photo media files, wherein after the web album list and the plural photo media file lists are received by the digital media server, the plural album identities, the plural album kinships, the plural album types, the plural photo identities, the plural photo kinships and the plural photo types are written into a metadata corresponding to the social networking site by the controlling unit, and the virtual folder is correlated with the social networking site by the controlling unit according to the plural album identities, the plural album kinships, the plural album types, the plural photo identities, the plural photo kinships and the plural photo types of the metadata.

14. The photo media playing system according to claim 13, wherein after the plural media thumbnails are selected through active control device, the plural photo media files are requested from the digital media server by the active control device and the plural photo media files are requested from the social networking site by the controlling unit, so that the plural photo media files are transmitted from the social networking site to the digital media server and the plural photo media files are transmitted from the digital media server to the active control device, wherein after the plural photo media files are transmitted to the active control device, the plural photo media files are played by the active control device, wherein the active control device is a digital media player, the area network complies with a DLNA protocol, and the network router complies with a UPnP protocol.

15. The photo media playing system according to claim 13, wherein the digital media renderer is connected to the network router through network connection and connected to the active control device and the digital media server via the network router through network connection, wherein after one of the plural media thumbnails displayed on the active control device is selected, the photo media file corresponding to the selected media thumbnail is requested from the digital media server by the active control device and the photo media file is requested from the social networking site by the controlling unit, so that the photo media file is transmitted from the social networking site to the digital media server and the photo media file is transmitted from the digital media server to the digital media renderer, wherein after the photo media file is transmitted to the digital media renderer, the photo media file is played by the digital media renderer, wherein the active control device is a digital media controller, the area network complies with a DLNA protocol, and the network router complies with a UPnP protocol.

16. The photo media playing system according to claim 11, wherein the digital media server comprises:
a storage element disposed within the digital media server, wherein the web album list, the plural photo media file lists, the plural media thumbnails and the plural photo media files are temporarily stored in the storage element; and
a controlling unit connected to the storage element, wherein the digital media server logins into the social networking site according to the account and the password after the account and the password corresponding to the social networking site are received by the controlling unit, or the web album list, the plural photo media file lists, the plural media thumbnails and the plural photo media files in the storage element are deleted after the web album list, the plural photo media file lists, the plural media thumbnails and the plural photo media files from the digital media server are received by the active control device.

17. The photo media playing system according to claim 16, wherein after one of the plural media thumbnails is selected through active control device, the photo media file is requested from the digital media server by the active control device and the photo media file is requested from the social networking site by the controlling unit, so that the photo media file is transmitted from the social networking site to the digital media server and the photo media file is transmitted from the digital media server to the active control device, wherein after the photo media file is transmitted to the active control device, the photo media file is played by the active control device, wherein the active control device is a digital media player, the area network complies with a DLNA protocol, and the network router complies with a UPnP protocol.

18. The photo media playing system according to claim 16, wherein the digital media renderer is connected to the network router through network connection and connected to the active control device and the digital media server via the network router through network connection, wherein after one of the plural media thumbnails displayed on the active control device is selected, the photo media file corresponding to the selected media thumbnail is requested from the digital media server by the active control device and the photo media file is requested from the social networking site by the controlling unit, so that the photo media file is transmitted from the social networking site to the digital media server and the photo media file is transmitted from the digital media server to the digital media renderer, wherein after the photo media file is transmitted to the digital media renderer, the photo media file is played by the digital media renderer, wherein the active control device is a digital media controller, the area network complies with a DLNA protocol, and the network router complies with a UPnP protocol.
